(19) United States
(12) Patent Application Publication
(10) Pub. No.: US 2026/0155128 A1
(43) Pub. Date: Jun. 4, 2026

(54) NOISE CANCELLING DEVICE

(71) Applicant: mpWAV Inc., Seoul (KR)

(72) Inventors: Hyung Min PARK, Seoul (KR); Byung Joon CHO, Seoul (KR)

(21) Appl. No.: 18/987,021

(22) Filed: Dec. 19, 2024

(30) Foreign Application Priority Data
Dec. 2, 2024 (KR) 10-2024-0176458

(51) Int. Cl. G10K 11/178; G10L 21/0208

(52) U.S. Cl. CPC G10K 11/17823; G10K 11/17854; G10L 21/0208

(57) ABSTRACT

A noise cancelling device according to an embodiment of the present disclosure includes a reference microphone selector, a target sound source canceller, and a noise canceller. The reference microphone selector selects reference microphone input vectors corresponding to some of microphone input vectors input by a plurality of microphones, and remaining microphone input vectors other than the reference microphone input vectors among the microphone input vectors. The target sound source canceller provides a noise output vector obtained by cancelling a component corresponding to a target sound source from the reference microphone input vectors. The noise canceller provides a result output vector based on the remaining microphone input vectors and the noise output vector.

### CROSS-REFERENCE TO RELATED APPLICATION(S)

This application is based on and claims priority under 35 U.S.C. § 119 to Korean Patent Application No. 10-2024-0176458, filed on Dec. 2, 2024, in the Korean Intellectual Property Office, the disclosure of which is incorporated by reference herein in its entirety.

### BACKGROUND

### Field

The present disclosure relates to a noise cancelling device.

### Description of the Related Art

An input signal input through a microphone may include not only target voice required for voice recognition, but also noises that interfere with voice recognition. Recently, various studies have been conducted to improve the performance of voice recognition by cancelling noise from input signals and extracting only desired target voice.

### SUMMARY

The present disclosure provides a noise cancelling device capable of more effectively cancelling noise from an input signal in which the noise is mixed with target voice, by providing a result output vector based on a noise output vector obtained by cancelling a component corresponding to a target sound source from reference microphone input vectors selected from among a plurality of microphone input vectors, and the remaining microphone input vectors.

According to an embodiment of the present disclosure, a noise cancelling device may include a reference microphone selector, a target sound source canceller, and a noise canceller. The reference microphone selector may select reference microphone input vectors corresponding to some of microphone input vectors input by a plurality of microphones, and remaining microphone input vectors other than the reference microphone input vectors among the microphone input vectors. The target sound source canceller may provide a noise output vector obtained by cancelling a component corresponding to a target sound source from the reference microphone input vectors. The noise canceller may provide a result output vector based on the remaining microphone input vectors and the noise output vector.

The reference microphone selector may include a determination unit. The determination unit may select the reference microphone input vectors based on whether a predetermined noise signal exists.

The determination unit may include a first selection unit and a second selection unit. The first selection unit may select the reference microphone input vectors based on a correlation between the noise signal and an input signal input to each of the plurality of microphones when the predetermined noise signal exists. The second selection unit may select the reference microphone input vectors based on a signal-to-noise ratio of the input signal when the predetermined noise signal does not exist.

The target sound source canceller may include a first output unit. The first output unit may provide the noise output vector based on the reference microphone input vectors, a first adaptive filter updated per frame, and a result-estimated output vector obtained by estimating the result output vector.

The target sound source canceller may further include a first calculation unit and a size provision unit. The first calculation unit may calculate a cross spectral density between the result-estimated output vector and a noise-estimated output vector obtained by estimating the noise output vector. The size provision unit may provide a step size determined based on the cross spectral density.

The noise canceller may include a second output unit. The second output unit may provide a result output vector based on the remaining microphone input vectors, a second adaptive filter updated per frame, and the noise-estimated output vector.

According to another embodiment of the present disclosure, a noise cancelling system may include a reference microphone selector, a target sound source canceller, a noise canceller, and a residual noise canceller. The reference microphone selector may select reference microphone input vectors corresponding to some of microphone input vectors input by a plurality of microphones, and remaining microphone input vectors other than the reference microphone input vectors among the microphone input vectors. The target sound source canceller may provide a noise output vector obtained by cancelling a component corresponding to a target sound source from the reference microphone input vectors. The noise canceller may provide a result output vector based on the remaining microphone input vectors and the noise output vector. The residual noise canceller may cancel residual noise included in the result output vector based on a weight vector and the result output vector to provide a final output signal.

The target sound source canceller may include a third output unit. The third output unit may provide the noise output vector based on the reference microphone input vectors, a third adaptive filter updated per frame, and a final estimated output signal obtained by estimating the final output signal.

The target sound source canceller may further include a second calculation unit and a size provision unit. The second calculation unit may calculate a cross spectral density between the final estimated output signal and a noise-estimated output vector obtained by estimating the noise output vector. The size provision unit may provide a step size determined based on the cross spectral density.

The noise canceller may include a fourth output unit. The fourth output unit may provide the result output vector based on the remaining microphone input vectors, a fourth adaptive filter updated per frame, and the noise-estimated output vector.

The residual noise canceller may include a fifth output unit. The fifth output unit may calculate a weight vector based on a final re-estimated output signal obtained by re-estimating the final output signal, and provide the final output signal based on the weight vector and the result output vector.

In addition to the technical aspects of the present disclosure discussed above, other features and advantages of the present disclosure will be set forth below, or may be apparent to those skilled in the art to which the present disclosure pertains from the following description.

According to the present disclosure, the following effect may be obtained.

The noise cancelling device according to the present disclosure is capable of more effectively cancelling noise from an input signal in which the noise is mixed with target voice, by providing a result output vector based on a noise output vector obtained by cancelling a component corresponding to a target sound source from reference microphone input vectors selected from among a plurality of microphone input vectors, and the remaining microphone input vectors.

Further, other features and advantages of the present disclosure may be understood through the embodiments of the present disclosure.

### BRIEF DESCRIPTION OF THE DRAWINGS

The above and/or other aspects of the disclosure will be more apparent by describing certain embodiments of the disclosure with reference to the accompanying drawings, in which:

FIG. 1 is a diagram illustrating a noise cancelling device according to embodiments of the present disclosure;

FIGS. 2 and 3 are diagrams for explaining an operation of a reference microphone selector included in the noise cancelling device of FIG. 1;

FIGS. 4 and 5 are diagrams for explaining an operation of a target sound source canceller included in the noise cancelling device of FIG. 1;

FIG. 6 is a diagram for explaining an operation of a noise canceller included in the noise cancelling device of FIG. 1;

FIG. 7 is a diagram illustrating a noise cancelling system according to embodiments of the present disclosure;

FIGS. 8 and 9 are diagrams illustrating a target sound source canceller included in the noise cancelling system of FIG. 7;

FIG. 10 is a diagram illustrating a noise canceller included in the noise cancelling system of FIG. 7; and

FIG. 11 is a diagram illustrating a residual noise canceller included in the noise cancelling system of FIG. 7.

### DETAILED DESCRIPTION

In the specification, in adding reference numerals for elements throughout the drawings, it should be noted that like reference numerals are used to denote like elements, wherever possible, even though the elements are shown in different drawings.

The terms used in the specification should be understood as follows.

Singular expressions should be understood to include plural expressions unless the context clearly indicates otherwise, and the scope should not be limited by these terms.

It should further be understood that the terms “include”, “have”, and the like do not preclude the presence or addition of one or more other features, integers, steps, operations, elements, parts, or combinations thereof.

Hereinafter, preferred embodiments of the present disclosure designed to solve the aforementioned problem will be described in detail with reference to the accompanying drawings.

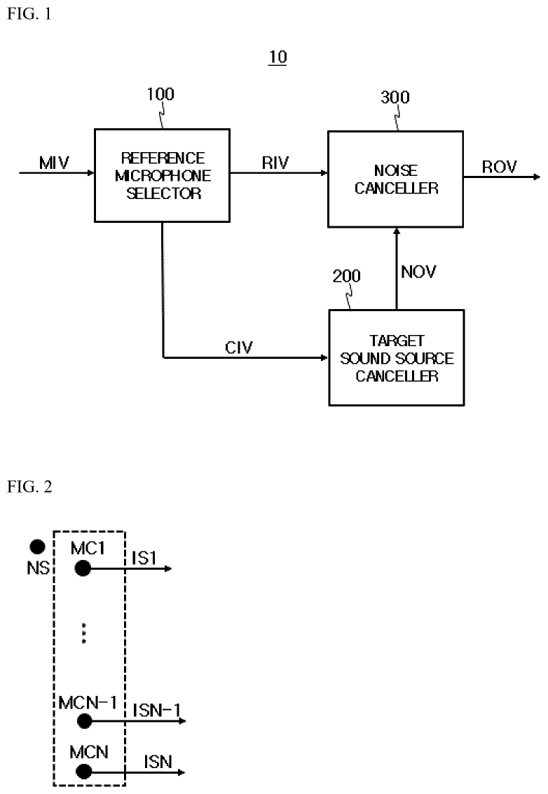

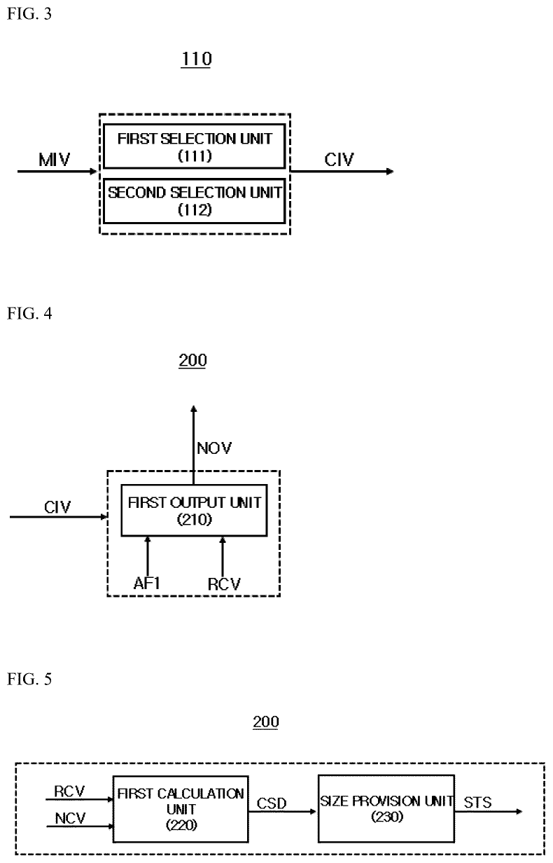

FIG. 1 is a diagram illustrating a noise cancelling device according to embodiments of the present disclosure, and FIGS. 2 and 3 are diagrams for explaining an operation of a reference microphone selector included in the noise cancelling device of FIG. 1.

Referring to FIGS. 1 to 3, a noise cancelling device 10 according to an embodiment of the present disclosure may include a reference microphone selector 100, a target sound source canceller 200, and a noise canceller 300. The reference microphone selector 100 may select reference microphone input vectors CIV corresponding to some of microphone input vectors MIV input by a plurality of microphones, and remaining microphone input vectors RIV other than the reference microphone input vectors CIV among the microphone input vectors MIV.

For example, the plurality of microphones may include a first microphone MC1 to an Nth microphone. Among the first microphone MC1 to the Nth microphone, a microphone disposed closest to a noise source NS may be the first microphone MC1. In this case, the reference microphone selector 100 may select a first microphone input vector MIV1 for a first input signal received by the first microphone MC1 as a reference microphone input vector CIV. Also, the reference microphone selector 100 may select microphone input vectors other than the first microphone input vector MIV1, which is the reference microphone input vector CIV among the microphone input vectors MIV, as remaining microphone input vectors RIV.

Here, the process of selecting one microphone input vector as the reference microphone input vector CIV by the reference microphone selector 100 is described, but the present disclosure is not limited thereto, and a plurality of microphone input vectors MIV may be selected as reference microphone input vectors CIV.

Also, although the first microphone MC1 to the Nth microphone MCN are arranged as illustrated in FIG. 2 here, the first microphone MC1 to the Nth microphone MCN may be arranged in various other forms.

In an embodiment, the reference microphone selector 100 may include a determination unit. The determination unit may select reference microphone input vectors CIV based on whether a predetermined noise signal exists.

In another embodiment, the determination unit 110 may include a first selection unit 111 and a second selection unit 112. When a predetermined noise signal exists, the first selection unit 111 may select reference microphone input vectors CIV based on a correlation between the noise signal and an input signal input to each of the plurality of microphones. The predetermined noise signal may include not only a case where the user knows the noise signal in advance, but also a case where the user knows the location of the noise source NS in advance. For example, the plurality of microphones may include a first microphone MC1 to an Nth microphone MCN, and the user may know in advance that a microphone disposed closest to the noise source NS is the first microphone MC1. In this case, the first selection unit 111 may select a first microphone input vector MIV1 corresponding to the first microphone MC1 as a reference microphone input vector CIV, or may select a reference microphone input vector CIV based on a correlation between the noise signal and an input signal input to each of the first microphone MC1 to the Nth microphone MCN. Here, a higher correlation may mean a closer distance between the microphone and the noise source NS. In this case, the first selection unit 111 may select a microphone input vector having the highest correlation as a reference microphone input vector CIV.

When the predetermined noise signal does not exist, the second selection unit 112 may select reference microphone input vectors CIV based on a signal-to-noise ratio SNR of the input signal. For example, the plurality of microphones may include a first microphone MC1 to an Nth microphone MCN. Here, a signal-to-noise ratio may be calculated for the input signal input to each of the first microphone MC1 to the Nth microphone MCN. In this case, the second selection unit 112 may select a microphone input vector having the lowest signal-to-noise ratio SNR as a reference microphone input vector CIV.

FIGS. 4 and 5 are diagrams for explaining an operation of the target sound source canceller included in the noise cancelling device of FIG. 1.

Referring to FIGS. 1 to 5, the target sound source canceller 200 may provide a noise output vector NOV obtained by cancelling a component corresponding to a target sound source from the reference microphone input vectors CIV.

In an embodiment, the target sound source canceller 200 may include a first output unit 210. The first output unit 210 may provide a noise output vector NOV based on the reference microphone input vectors CIV, a first adaptive filter AF1 updated per frame, and a result-estimated output vector RCV obtained by estimating a result output vector ROV. Here, the frame interval may be a predetermined time interval. For example, the noise output vector NOV may be expressed as shown in the following Formula 1:

$${v}_{l , k} = {\tilde{x}}_{l , k} - {C}_{l , k}^{H} {{z}^{\hat{\_}}}_{j , l , k} , \qquad [ Formul 1 ]$$

$${v}_{l , k} = {[ {V}_{1 , l , k} , {V}_{2 , l , k} , … , {V}_{{N}_{r} , l , k} ]}^{T} ,$$

$${x}_{l , k} \text{?} = {[ {X}_{1 , l , k} \text{?} , {X}_{2 , l , k} \text{?} , … , {X}_{{N}_{r} , l , k} \text{?} ]}^{T} ,$$

$${z}_{j , l , k} \text{?} = {[ {\hat{Z}}_{j , l , k} , {Z}_{j , l - 1 , k} , … , {Z}_{j , l -} \text{?} ]}^{T} ,$$

$${C}_{l , k} = [ {c}_{1 , l , k} , {c}_{2 , l , k} , … , {c}_{{N}_{r} , l , k} ] ,$$

$${c}_{i , l , k} = {[ {C}_{i , 0 , l , k} , {C}_{i , 1 , l , k} , … , {C}_{i , {L}_{r} - 1 , l , k} ]}^{T}$$

$$\text{?} \text{indicates text missing or illegible when filed}$$

where v_{l,k} denotes a noise output vector, \tilde{x}_{l,k} denotes reference microphone input vectors,

$${C}_{l , k}^{H}$$

denotes a first adaptive filter, denotes a first adaptive filter, reference microphone input vectors, denotes a result-estimated output vector corresponding to any j microphones among the remaining microphone input vectors, Nᵣ denotes the number of reference microphones, Lᵣ denotes the number of taps of the first adaptive filter, l denotes a frame index, k denotes a frequency index, j denotes a remaining microphone index, and i denotes a reference microphone index.

In addition, the result-estimated output vector RCV may be expressed as shown in the following Formula 2:

$${\hat{z}}_{l , k} = {x}_{l , k} - {\sum }_{i = 1}^{{N}_{r}} {Q}_{i , l - 1 , k}^{H} {\hat{\overline{v}}}_{i , l , k} , \\ {\hat{z}}_{l , k} = {[ {\hat{Z}}_{1 , l , k} , … , {\hat{Z}}_{{N}_{m} , l , k} ]}^{T} , {x}_{l , k} = {[ {X}_{1 , l , k} , {X}_{2 , i , k} , … , {X}_{{N}_{m} , l , k} ]}^{T} , {Q}_{i , l , k} = [ {q}_{i , 1 , l , k} , {q}_{i , 2 , l , k} , … , {q}_{i , {N}_{m} , l , k} ] , {q}_{i , j , l , k} = {[ {Q}_{i , j , 0 , l , k} , {Q}_{i , j , 1 , l , k} , … , {Q}_{i , j , {L}_{m} - 1 , l , k} ]}^{T} , \\ {\hat{\overline{v}}}_{i , l , k} = {[ {\tilde{X}}_{i , l , k} , {V}_{i , l - 1 , k} , … , {V}_{i , l - {L}_{m} + 1 , k} ]}^{T} \qquad [ Formula 2 ]$$

where \hat{z}_{l,k} denotes a result-estimated output vector, x_{l,k} denotes remaining microphone input vectors,

$${Q}_{i , l - 1 , k}^{H}$$

denotes a second adaptive filter corresponding to i reference microphones among the reference microphone input vectors, \overline{\hat{v}}_{i,l,k} denotes a noise-estimated output vector corresponding to the i reference microphones among the reference microphone input vectors, Nₘ denotes the number of remaining microphones, and Lₘ denotes the number of taps of the second adaptive filter.

In addition, the noise-estimated output vector NCV may be expressed as shown in the following Formula 3:

$${\hat{v}}_{l , k} = {\tilde{x}}_{l , k} - {C}_{l - 1 , k}^{H} {\hat{\overline{z}}}_{j , l , k} , \\ {\hat{v}}_{l , k} = {[ {\hat{V}}_{1 , l , k} , … , {\hat{V}}_{i , l , k} , … , {\hat{V}}_{{N}_{r} , l , k} ]}^{T} \qquad [ Formula 3 ]$$

where \hat{v}_{l,k} denotes a noise-estimated output vector, \hat{V}_{i,l,k} denotes a noise-estimated signal corresponding to i reference microphones, \tilde{x}_{l,k} denotes reference microphone input vectors,

$${C}_{l - 1}^{H}$$

denotes a first adaptive filter, and \overline{\hat{z}}_{j,l,k} denotes a result-estimated output vector corresponding to any j microphones among the remaining microphone input vectors.

The target sound source canceller 200 included in the noise cancelling device 10 according to the present disclosure is capable of more effectively cancelling a noise component included in the remaining microphones by reliably cancelling a target sound source component included in the reference microphone input vectors and providing them to the noise canceller 300.

In an embodiment, the target sound source canceller 200 may further include a first calculation unit 220 and a size provision unit 230.

The first calculation unit 220 may calculate a cross spectral density CSD between the result-estimated output vector RCV and the noise-estimated output vector NCV obtained by estimating a noise output vector NOV.

For example, a time-varying variance for the noise-estimated output vector NCV may be expressed as shown in the following Formula 4:

$${\hat{λ}}_{{V}_{i} , l , k} = {\vert {\hat{V}}_{i , l , k} \vert}^{2} = {\vert {\tilde{X}}_{i , l , k} - {c}_{i , l - 1 , k}^{H} {\hat{\overline{z}}}_{j , l , k} \vert}^{2} \qquad [ Formula 4 ]$$

where \hat{λ}_{V}_{_{i,l,k}} denotes a time-varying variance for a noise-estimated signal corresponding to i reference microphones, \hat{V}_{i,l,k} denotes a noise-estimated signal corresponding to the i reference microphones, \hat{X}_{i,l,k} denotes an i reference microphone input signal,

$${c}_{i , l - 1}^{H}$$

denotes a first adaptive filter corresponding to the i reference microphones, and \overline{\hat{z}}_{j,l,k} denotes a result-estimated output vector corresponding to any j microphones among the remaining microphone input vectors.

In addition, a power spectral density (PSD) of the noise-estimated output vector NCV may be expressed as shown in the following Formula 5:

$${Φ}_{i , l , k} = {α}_{k} {Φ}_{i , l - 1 , k} + ( 1 - {α}_{k} ) {\vert {\hat{V}}_{i , l , k} \vert}^{2} \qquad [ Formula 5 ]$$

where Φ_{i,l,k} denotes a power spectral density corresponding to i reference microphones, and αₖ denotes a smoothing constant.

In addition, a cross spectral density CSD between the noise-estimated output vector NCV and the result-estimated output vector RCV may be expressed as shown in the following Formula 6:

$${Ψ}_{i , l , k} = {α}_{k} {Ψ}_{i , l - 1 , k} + ( 1 - {α}_{k} ) {\hat{Z}}_{j , l , k}^{*} {\hat{V}}_{i . , l , k} \qquad [ Formula 6 ]$$

where Ψ_{i,l,k} denotes a cross spectral density corresponding to i reference microphones, and αₖ denotes a smoothing constant.

In an embodiment, the size provision unit 230 may provide a step size STS determined based on the cross spectral density. For example, the step size STS may be expressed as shown in the following Formula 7:

$${μ}_{i , l , k} = {β}_{k} min ( \frac{\vert {Ψ}_{i , l , k} \vert}{{Φ}_{i , l , k}} , 1 ) , \\ {μ}_{i , l , k} = {\overline{M}}_{l , k} {β}_{k} min ( \frac{\vert {Ψ}_{i , l , k} \vert}{{Φ}_{i , l , k}} , 1 ) \qquad [ Formula 7 ]$$

where μ_{i,l,k} denotes a step size corresponding to i reference microphones, denotes a constant, and M̅_{l,k} denotes a mask.

In addition, the update of the first adaptive filter AF1 may be expressed as shown in the following Formula 8:

$${c}_{i , l , k} = {c}_{i , l - 1 , k} + \frac{{μ}_{i , l , k}}{{\hat{λ}}_{{V}_{i} , l , k} + ϵ} {\hat{\overline{z}}}_{j , l , k} {\hat{V}}_{i , l , k}^{*} , {c}_{i , l , k} = {c}_{i , l - 1 , k} + \frac{{μ}_{i , l , k}}{\sqrt{{\hat{λ}}_{{V}_{i} , l , k} {‖ {\hat{\overline{z}}}_{j , l , k} ‖}^{2} + ϵ}} {\hat{\overline{z}}}_{j , l , k} {\hat{V}}_{i , l , k}^{*} \qquad [ Formula 8 ]$$

where c_{i,l,k} denotes a first adaptive filter corresponding to i reference microphones, μ_{i,l,k} denotes a step size corresponding to the i reference microphones, \hat{λ}_{V}_{_{i,l,k}} denotes a time-varying variance for a noise-estimated signal corresponding to the i reference microphones, and ϵ denotes a constant.

In addition, here, the process of updating the first adaptive filter AF1 may be performed by sequentially increasing the reference microphone index i in Formula 4 to Formula 8 by 1 from i=1 to i=Nᵣ.

In addition, here, the process of updating the first adaptive filter AF1 may include a process of finding a parameter set that maximizes a log-likelihood function.

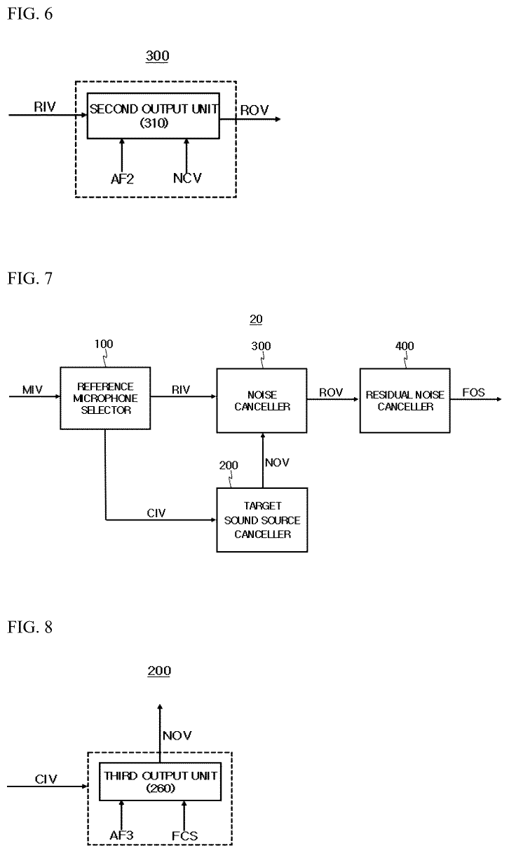

FIG. 6 is a diagram for explaining an operation of a noise canceller included in the noise cancelling device of FIG. 1.

Referring to FIGS. 1 to 6, the noise canceller 300 may provide a result output vector ROV based on the remaining microphone input vectors RIV and the noise output vector NOV.

In an embodiment, the noise canceller 300 may include a second output unit 310. The second output unit 310 may provide a result output vector ROV based on the remaining microphone input vectors RIV, a second adaptive filter AF2 updated per frame, and the noise-estimated output vector NCV.

For example, the result output vector ROV may be expressed as shown in the following Formula 9:

$${z}_{l , k} = {x}_{l , k} - {\sum }_{i = 1}^{{N}_{r}} {Q}_{i , l , k}^{H} {\overline{v}}_{i , l , k} , \\ {z}_{l , k} = {[ {Z}_{1 , l , k} , {Z}_{2 , l , k} , … , {Z}_{{N}_{m} , l , k} ]}^{T} , \\ {\overline{v}}_{i , l , k} = {[ {V}_{i , l , k} , {V}_{i , l - 1 , k} , … , {V}_{i , l - {L}_{m} + 1 , k} ]}^{T} \qquad [ Formula 9 ]$$

where

z_{l,k} denotes a result output vector, x_{l,k} denotes remaining microphone input vectors,

$${Q}_{i , l , k}^{H}$$

denotes a second adaptive filter corresponding to i reference microphones, and v̅_{i,l,k} denotes a noise output vector corresponding to the i reference microphones.

In addition, for example, the update of the second adaptive filter AF2 may be expressed as shown in the following Formula 10:

$${Q}_{i , l , k} = {Q}_{i , l - 1 , k} + {\hat{k}}_{i , l , k} {\check{z}}_{i , j , k}^{H} \qquad [ Formula 10 ]$$

where Q_{i,l,k} denotes a second adaptive filter corresponding to i reference microphones, \hat{k}_{i,l,k} denotes a gain vector corresponding to the i reference microphones, and

$${\check{z}}_{i , j , k}^{H}$$

denotes a result-estimated output vector RCV corresponding to the i reference microphones.

In addition, for example, the gain vector may be expressed as shown in the following Formula 11:

$${\hat{k}}_{i , l , k} = \frac{{Φ}_{i , l - 1 , k} {\overline{v}}_{i , l , k}}{γ {\hat{λ}}_{z , i , l , k} + {\overline{v}}_{i , l , k}^{H} {Φ}_{i , l - 1 , k} {\overline{v}}_{i , l , k}} \qquad [ Formula 11 ]$$

where \hat{k}_{i,l,k} denotes a gain vector corresponding to i reference microphones, \hat{λ}_{z,i,l,k} denotes a time-varying variance for a result-estimated output vector corresponding to the i reference microphones, and Φ_{i,l-1,k} denotes an inverse covariance matrix of a noise output vector corresponding to the i reference microphones.

In addition, for example, the time-varying variance for the result-estimated output vector may be expressed as shown in the following Formula 12:

$${\hat{λ}}_{z , i , l , k} = {‖ {\check{z}}_{i , j , k} ‖}^{2} \qquad [ Formula 12 ]$$

where \hat{λ}_{z,i,l,k} denotes a time-varying variance for a result-estimated output vector corresponding to i reference microphones, and ž_{i,j,k} denotes a result-estimated output vector corresponding to the i reference microphones.

In addition, for example, the result-estimated output vector RCV may be expressed as shown in the following Formula 13:

$${\check{z}}_{i , j , k} = {x}_{l , k} - {\sum }_{{i}^{′} = 1}^{i - 1} {Q}_{{i}^{′} , l , k}^{H} {\overline{v}}_{{i}^{′} , l , k} - {\sum }_{{i}^{′} = i}^{{N}_{r}} {Q}_{{i}^{′} , l - 1 , k}^{H} {\overline{v}}_{{i}^{′} , l , k} \qquad [ Formula 13 ]$$

where ž_{i,j,k} denotes a result-estimated output vector corresponding to i reference microphones,

$${Q}_{{i}^{′} , l , k}^{H}$$

denotes a second adaptive filter corresponding to i′ reference microphones, and v̅_{i′,l,k} denotes a noise-estimated output vector NCV corresponding to the i′ reference microphones.

In addition, for example, the inverse covariance matrix for the noise output vector NOV may be updated as shown in the following Formula 14:

$${Φ}_{i , l , k} = {γ}^{- 1} ( {Φ}_{i , l - 1 , k} - {\hat{k}}_{i , l , k} {\overline{v}}_{i , l , k}^{H} {Φ}_{i , l - 1 , k} ) \qquad [ Formula 14 ]$$

where Φ_{i,l,k} denotes an inverse covariance matrix of a noise output vector corresponding to i reference microphones, and γ denotes a forgetting factor.

In addition, here, the process of updating the second adaptive filter AF2 may be performed by sequentially increasing the reference microphone index i by 1 from i=1 to i=Nᵣ.

In addition, here, the process of updating the second adaptive filter AF2 may include a process of finding a parameter set that maximizes a log-likelihood function.

The noise cancelling device 10 according to the present disclosure is capable of more effectively cancelling noise from an input signal in which target voice and noise are mixed, by providing a result output vector ROV based on a noise output vector NOV obtained by cancelling a component corresponding to a target sound source from the reference microphone input vectors CIV selected from among the plurality of microphone input vectors MIV and the remaining microphone input vectors RIV.

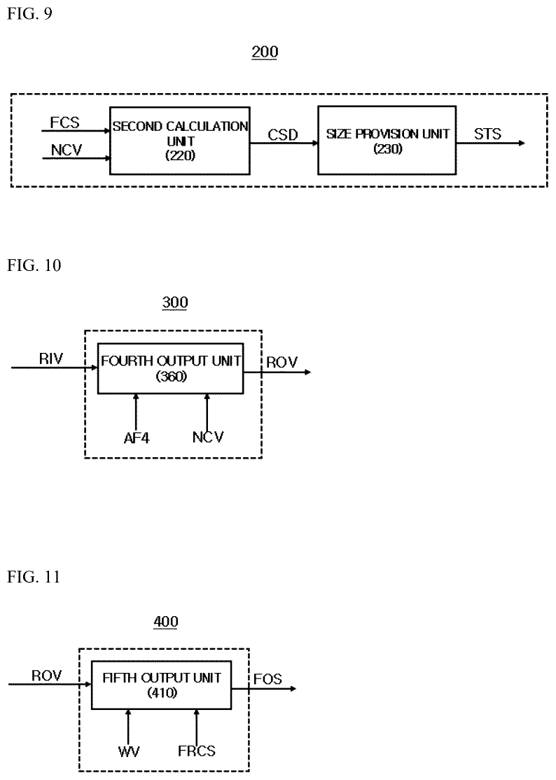

FIG. 7 is a diagram illustrating a noise cancelling system according to embodiments of the present disclosure, and FIGS. 8 and 9 are diagrams illustrating a target sound source canceller included in the noise cancelling system of FIG. 7.

Referring to FIGS. 1 to 9, a noise cancelling system 20 according to an embodiment of the present disclosure may include a reference microphone selector 100, a target sound source canceller 200, a noise canceller 300, and a residual noise canceller 400. The reference microphone selector 100 may select reference microphone input vectors CIV corresponding to some of microphone input vectors MIV input by a plurality of microphones, and remaining microphone input vectors RIV other than the reference microphone input vectors CIV among the microphone input vectors MIV.

The target sound source canceller 200 may provide a noise output vector NOV obtained by cancelling a component corresponding to a target sound source from the reference microphone input vectors CIV.

In an embodiment, the target sound source canceller 200 may include a third output unit 260. The third output unit 260 may provide a noise output vector NOV based on the reference microphone input vectors CIV, a third adaptive filter AF3 updated per frame, and a final estimated output signal FCS obtained by estimating a final output signal FOS.

For example, the noise output vector NOV may be expressed as shown in the following Formula 15:

$${v}_{l , k} = {\tilde{x}}_{l , k} - {C}_{l , k}^{H} {\hat{y}}_{l , k} , \qquad [ Formula 15 ]$$

$${\hat{y}}_{l , k} = {[ {\hat{Y}}_{l , k} , {Y}_{l - 1 , k} , … , {Y}_{l - {L}_{r} + 1 , k} ]}^{T}$$

where v_{l,k} denotes a noise output vector, \tilde{x}_{l,k} denotes reference microphone input vectors,

$${C}_{l , k}^{H}$$

denotes a third adaptive filter, ŷ_{l,k} denotes a final estimated output vector, Ŷ_{l,k} denotes a final estimated output signal, Lᵣ denotes the number of taps of the third adaptive filter, l denotes a frame index, and k denotes a frequency index.

In addition, the final estimated output signal FCS may be expressed as shown in the following Formula 16:

$${\hat{Y}}_{l , k} = {w}_{l - 1 , k}^{H} {\hat{z}}_{l , k} , \qquad [ Formula 16 ]$$

$${\hat{z}}_{l , k} = {x}_{l , k} - {\sum }_{i = 1}^{{N}_{r}} {Q}_{i , l - 1 , k}^{H} {{v}^{\tilde{\_}}}_{i , l , k}$$

where Ŷ_{l,k} denotes a final estimated output signal,

$${w}_{l - 1 , k}^{H}$$

denotes a weight vector, \hat{z}_{l,k} denotes a result-estimated output vector,

$${Q}_{i , l - 1 , l}^{H}$$

denotes a fourth adaptive filter corresponding to i reference microphones, \overline{\hat{v}}_{i,l,k} denotes a noise-estimated output vector corresponding to the i reference microphones, and i denotes a reference microphone index.

In addition, the noise-estimated output vector NCV may be expressed as shown in the following Formula 17:

$${\hat{v}}_{l , k} = {\tilde{x}}_{l , k} - {C}_{l - 1 , k}^{H} {\hat{y}}_{l , k} \qquad [ Formula 17 ]$$

where \hat{v}_{l,k} denotes a noise-estimated output vector, \tilde{x}_{l,k} denotes reference microphone input vectors,

$${C}_{l - 1 , k}^{H}$$

denotes a third adaptive filter, and ŷ_{l,k} denotes a final estimated output vector.

In an embodiment, the target sound source canceller 200 may further include a second calculation unit 220 and a size provision unit 230. The second calculation unit 220 may calculate a cross spectral density CSD between the final estimated output signal FCS and the noise-estimated output vector NCV obtained by estimating a noise output vector NOV. The size provision unit 230 may provide a step size STS determined based on the cross spectral density.

For example, the process of providing a step size STS by using a cross spectral density between the noise-estimated output vector NCV and the result-estimated output vector RCV and a power spectral density of the noise-estimated output vector NCV may be identically applied to the process of providing a step size STS by using a cross spectral density between the noise-estimated output vector NCV and the final estimated output signal FCS and a power spectral density of the noise-estimated output vector NCV.

In addition, the update of the third adaptive filter AF3 may be expressed as shown in the following Formula 18:

$${c}_{i , l , k} = {c}_{i , l - 1 , k} + \frac{{μ}_{i , l , k}}{{\hat{λ}}_{Y , l , k} + ϵ} {\hat{y}}_{l , k} {\hat{V}}_{i , l , k}^{*} , \qquad [ Formula 18 ]$$

$${c}_{i , l , k} = {c}_{i , l - 1 , k} + \frac{{μ}_{i , l , k}}{\sqrt{{\hat{λ}}_{Y , l , k} {‖ {\hat{y}}_{l , k} ‖}^{2}} + ϵ} {\hat{y}}_{l , k} {\hat{V}}_{i , l , k}^{*}$$

where c_{i,l,k} denotes a third adaptive filter corresponding to i reference microphones, μ_{i,l,k} denotes a step size corresponding to the i reference microphones, \hat{λ}_{Y,l,k} denotes a time-varying variance for a final estimated output signal, and ϵ denotes a constant.

In addition, here, the time-varying variance for the final estimated output signal may be expressed as shown in the following Formula 19:

$${\hat{λ}}_{Y , / , k} = {\vert {\hat{Y}}_{l , k} \vert}^{2} = {\vert {w}_{l - 1 , k}^{H} {\hat{z}}_{l , k} \vert}^{2} \qquad [ Formula 19 ]$$

where \hat{λ}_{Y,l,k} denotes a time-varying variance for a final estimated output signal,

$${w}_{l - 1 , k}^{H}$$

denotes a weight vector, and \hat{z}_{l,k} denotes a result-estimated output vector.

In addition, here, the process of updating the third adaptive filter AF3 may be performed by sequentially increasing the reference microphone index i by 1 from i=1 to i=Nᵣ.

In addition, here, the process of updating the third adaptive filter AF3 may include a process of finding a parameter set that maximizes a log-likelihood function.

FIG. 10 is a diagram illustrating the noise canceller included in the noise cancelling system of FIG. 7.

Referring to FIGS. 1 to 10, the noise canceller 300 may provide a result output vector ROV based on the remaining microphone input vectors RIV and the noise output vector NOV.

In an embodiment, the noise canceller 300 may include a fourth output unit 360. The fourth output unit 360 may provide a result output vector ROV based on the remaining microphone input vectors RIV, a fourth adaptive filter AF4 updated per frame, and the noise-estimated output vector NCV.

For example, the result output vector ROV may be expressed as shown in the following Formula 20:

$${z}_{l , k} = {x}_{l , k} - {\sum }_{i = 1}^{{N}_{r}} {Q}_{i , l , k}^{H} {\overline{v}}_{i , l , k} \qquad [ Formula 20 ]$$

where z_{l,k} denotes a result output vector, x_{l,k} denotes remaining microphone input vectors,

$${Q}_{i , l , k}^{H}$$

denotes a fourth adaptive filter corresponding to i reference microphones, and v̅_{i,l,k} denotes a noise-estimated output vector corresponding to the i reference microphones.

In addition, for example, the fourth adaptive filter AF4 may be updated as shown in the following Formula 21:

$${Q}_{i , l , k} = {Q}_{i , l - 1 , k} + {\hat{k}}_{i , l , k} {\check{z}}_{i , j , k}^{H} \qquad [ Formula 21 ]$$

where

$${Q}_{i , l , k}^{H}$$

denotes a fourth adaptive filter corresponding to i reference microphones, \hat{k}_{i,l,k} denotes a gain vector corresponding to the i reference microphones, and

$${\check{z}}_{i , j , k}^{H}$$

denotes a result-estimated output vector corresponding to the i reference microphones.

In addition, for example, the gain vector may be expressed as shown in the following Formula 22:

$${\hat{k}}_{i , l , k} = \frac{{Φ}_{i , l - 1 , k} {\overline{v}}_{i , l , k}}{γ {\hat{λ}}_{i , l , k} + {\overline{v}}_{i , l , k}^{H} {Φ}_{i , l - 1 , k} {\overline{v}}_{i , l , k}} \qquad [ Formula 22 ]$$

where \hat{k}_{i,l,k} denotes a gain vector corresponding to i reference microphones, \hat{λ}_{i,l,k} denotes a time-varying variance for a final estimated output signal corresponding to the i reference microphones, and Φ_{i,l-1,k} denotes an inverse covariance matrix of a noise output vector corresponding to the i reference microphones.

In addition, here, the inverse covariance matrix of the noise output vector corresponding to the i reference microphones may be updated in the same way as shown in Formula 14 for the process of updating the second adaptive filter AF2.

In addition, here, the time-varying variance for the final estimated output signal corresponding to the i reference microphones may be expressed as shown in the following Formula 23:

$${\hat{λ}}_{i , l , k} = {\vert {w}_{l - 1 , k}^{H} {\check{z}}_{i , j , k} \vert}^{2} \qquad [ Formula 23 ]$$

where \hat{λ}_{i,l,k} denotes a time-varying variance for a final estimated output signal corresponding to i reference microphones,

$${w}_{l - 1 , k}^{H}$$

denotes a weight vector, and

$${\check{z}}_{i , j , k}^{H}$$

denotes a result-estimated output vector corresponding to the i reference microphones.

In addition, here, the process of updating the fourth adaptive filter AF4 may be performed by sequentially increasing the reference microphone index i by 1 from i=1 to i=Nᵣ.

In addition, here, the process of updating the fourth adaptive filter AF4 may include a process of finding a parameter set that maximizes a log-likelihood function.

FIG. 11 is a diagram illustrating the residual noise canceller included in the noise cancelling system of FIG. 7.

Referring to FIGS. 1 to 11, the residual noise canceller 400 may cancel residual noise included in the result output vector ROV based on the result output vector ROV and the weight vector WV to provide a final output signal FOS.

In an embodiment, the residual noise canceller 400 may include a fifth output unit 410. The fifth output unit 410 may provide a final output signal FOS by calculating a weight vector WV based on a final re-estimated output signal FRCS obtained by re-estimating a final output signal, and cancelling residual noise included in the result output vector ROV based on the weight vector WV and the result output vector ROV.

For example, the final output signal FOS may be expressed as shown in the following Formula 24:

$${Y}_{l , k} = {w}_{l , k}^{H} {z}_{l , k} \qquad [ Formula 24 ]$$

where Y_{l,k} denotes a final output signal,

$${w}_{l , k}^{H}$$

is a weight vector WV, and z_{l,k} denotes a result output vector ROV.

In addition, here, the weight vector WV may be expressed as shown in the following Formula 25:

$${w}_{l , k} = \frac{{Ω}_{l , k} {h}_{l , k}}{{h}_{l , k}^{H} {Ω}_{l , k} {h}_{l , k}} \qquad [ Formula 25 ]$$

where w_{l,k} denotes a weight vector, h_{l,k} denotes a direction vector, and Ω_{l,k} denotes an inverse covariance matrix of a result output vector.

In addition, here, the inverse covariance matrix of the result output vector may be updated as shown in the following Formula 26:

$${Ω}_{l , k} = \frac{1}{γ} ( {Ω}_{l - 1 , k} - \frac{{Ω}_{l - 1 , k} {z}_{l , k} {z}_{l , k}^{H} {Ω}_{l - 1 , k}}{γ {\tilde{λ}}_{l , k} + {z}_{l , k}^{H} {Ω}_{l - 1 , k} {z}_{l , k}} ) \qquad [ Formula 26 ]$$

where Ω_{l,k} denotes an inverse covariance matrix of a result output vector, z_{l,k} denotes a result output vector, \tilde{λ}_{l,k} denotes a time-varying variance for a final re-estimated output signal FRCS, and γ denotes a forgetting factor.

In addition, here, the time-varying variance for the final re-estimated output signal FRCS may be updated as shown in the following Formula 27:

$${\tilde{λ}}_{l , k} = {\vert {\tilde{Y}}_{l , k} \vert}^{2} = {\vert {w}_{l - 1 , k}^{H} {z}_{l , k} \vert}^{2} \qquad [ Formula 27 ]$$

where \tilde{λ}_{l,k} denotes a time-varying variance for a final re-estimated output signal, \tilde{Y}_{l,k} denotes a final re-estimated output signal FRCS,

$${w}_{l - 1}^{H}$$

denotes a weight vector, and z_{l,k} denotes a result output vector.

The noise cancelling system 20 according to the present disclosure is capable of more effectively cancelling noise from an input signal in which target voice and noise are mixed, by providing a result output vector ROV based on a noise output vector NOV obtained by cancelling a component corresponding to a target sound source from the reference microphone input vectors CIV selected from among the plurality of microphone input vectors MIV and the remaining microphone input vectors RIV, and providing a final output signal based on the weight vector WV and the result output vector ROV.

In an embodiment, the first adaptive filter AF1 may be updated by estimating a time-varying variance for the output of the first output unit 210, and the second adaptive filter AF2 may be updated by estimating a time-varying variance for the output of the second output unit 310. Here, the output of the first output unit may be a noise output vector NOV, and the output of the second output unit may be a result output vector ROV.

In an embodiment, the third adaptive filter AF3 and the fourth adaptive filter AF4 may be updated by estimating a final output signal FOS based on the weight vector WV.

In an embodiment, the weight vector WV may be updated by estimating a final output signal FOS.

What is claimed is:

1. A noise cancelling device comprising:
a reference microphone selector configured to select reference microphone input vectors corresponding to some of microphone input vectors input by a plurality of microphones, and remaining microphone input vectors other than the reference microphone input vectors among the microphone input vectors;
a target sound source canceller configured to provide a noise output vector obtained by cancelling a component corresponding to a target sound source from the reference microphone input vectors; and
a noise canceller configured to provide a result output vector based on the remaining microphone input vectors and the noise output vector.

2. The noise cancelling device of claim 1, wherein the reference microphone selector includes a determination unit configured to select the reference microphone input vectors based on whether a predetermined noise signal exists.

3. The noise cancelling device of claim 2, wherein the determination unit includes:
a first selection unit configured to select the reference microphone input vectors based on a correlation between the noise signal and an input signal input to each of the plurality of microphones when the predetermined noise signal exists; and
a second selection unit configured to select the reference microphone input vectors based on a signal-to-noise ratio of the input signal when the predetermined noise signal does not exist.

4. The noise cancelling device of claim 3, wherein the target sound source canceller includes a first output unit configured to provide the noise output vector based on the reference microphone input vectors, a first adaptive filter updated per frame, and a result-estimated output vector obtained by estimating the result output vector.

5. The noise cancelling device of claim 4, wherein the target sound source canceller further includes:
a first calculation unit configured to calculate a cross spectral density between the result-estimated output vector and a noise-estimated output vector obtained by estimating the noise output vector; and
a size provision unit configured to provide a step size determined based on the cross spectral density.

6. The noise cancelling device of claim 5, wherein the noise canceller includes a second output unit configured to provide the result output vector based on the remaining microphone input vectors, a second adaptive filter updated per frame, and the noise-estimated output vector.

7. A noise cancelling system comprising:
a reference microphone selector configured to select reference microphone input vectors corresponding to some of microphone input vectors input by a plurality of microphones, and remaining microphone input vectors other than the reference microphone input vectors among the microphone input vectors;
a target sound source canceller configured to provide a noise output vector obtained by cancelling a component corresponding to a target sound source from the reference microphone input vectors;
a noise canceller configured to provide a result output vector based on the remaining microphone input vectors and the noise output vector; and
a residual noise canceller configured to cancel residual noise included in the result output vector to provide a final output signal.

8. The noise cancelling system of claim 7, wherein the target sound source canceller includes a third output unit configured to provide the noise output vector based on the reference microphone input vectors, a third adaptive filter updated per frame, and a final estimated output signal obtained by estimating the final output signal.

9. The noise cancelling system of claim 8, wherein the target sound source canceller further includes:
a second calculation unit configured to calculate a cross spectral density between the final estimated output signal and a noise-estimated output vector obtained by estimating the noise output vector; and
a size provision unit configured to provide a step size determined based on the cross spectral density.

10. The noise cancelling system of claim 9, wherein the noise canceller includes a fourth output unit configured to provide the result output vector based on the remaining microphone input vectors, a fourth adaptive filter updated per frame, and the noise-estimated output vector.

11. The noise cancelling system of claim 10, wherein the residual noise canceller includes a fifth output unit configured to calculate a weight vector based on a final re-estimated output signal obtained by re-estimating the final output signal, and provide the final output signal based on the weight vector and the result output vector.

12. The noise cancelling device of claim 6, wherein the first adaptive filter is updated by estimating a time-varying variance for the output of the first output unit, and the second adaptive filter is updated by estimating a time-varying variance for the output of the second output unit.

13. The noise cancelling system of claim 11, wherein the third adaptive filter and the fourth adaptive filter are updated by estimating the final output signal based on the weight vector.

14. The noise cancelling system of claim 13, wherein the weight vector is updated by estimating the final output signal.
